(19) United States
(12) Patent Application Publication
(10) Pub. No.: US 2006/0227376 A1
(43) Pub. Date: Oct. 12, 2006

(54) Secure image data system and method

(75) Inventor: Mitsuhiro Kinoshita, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/091,768

(22) Filed: Mar. 29, 2005

(51) Int. Cl. G06K 15/00

(52) U.S. Cl. 358/1.16

(57) ABSTRACT

In a system and method for controlling access to image data stored in a hardcopy device, operation of the hardcopy device is monitored to detect an inoperable condition. The image data associated with the job request being processed when the inoperable printing condition occurs is identified. The identified image data is overwritten.

### FIELD OF INVENTION

The present invention relates generally to image processing and more particularly to a system and method for controlling access to image data stored by a multi-function peripheral (MFP) and similar devices.

### BACKGROUND OF THE INVENTION

In both stand-alone and network systems, a user may connect a computer, such as a personal computer (PC) or server, to one or more peripheral devices. The peripheral devices may be one or more hardcopy devices, such as a printer, a facsimile, a scanner or a photocopier. Other peripheral devices may also be attached to the computer including disk drives, CD-ROMs and other storage devices, as well as audio and video equipment.

For hardcopy devices, it is possible to have a single device, referred to as a multi-function peripheral (MFP), perform multiple functions including printing, copying, faxing, scanning and receipt of electronic document transmissions via fax or email. Using an MFP provides several benefits. For example, an MFP has a small footprint for the combination of functionality. It saves cost for low-duty use by sharing toner or ink for printing, copying and faxing. An MFP also provides a single device for all document/paper-related needs.

Like some other hardcopy devices, the MFP stores certain information for proper operation. For example, to receive a fax, the MFP stores a fax number. To be accessible via a LAN or via the Internet, the MFP is assigned and stores a unique address, such as an IP address. The MFP may also store custom information that is used by the user to control the operation of the MFP. For example, the MFP may store an address book used by the user to identify where to send a fax or an e-mail. The MFP may also store setting information, such as resolutions and fonts to use when printing a document or receiving a fax.

Generally, an MFP is capable of receiving faxes from phone lines, a LAN, or other communication networks. Using similar communication methods, an MFP is also capable of receiving job requests to copy, print or scan an image or a file. The MFP processes the received job request and performs the function or job specified in the job request. For example, the job request may require the MFP to copy image data or print out image data sent via facsimile. Generally, the MFP has a hard disk drive (HDD) that is capable of storing various information including image data related to fax, copy, print or scan jobs.

### SUMMARY OF THE INVENTION

Briefly, in one aspect of the invention, a method for controlling access to image data in a hardcopy device comprises receiving a job request, storing image data associated with the job request onto a storage medium, detecting an inoperable condition of the hardcopy device and overwriting the image data associated with the job request in the storage medium when the inoperable condition is detected.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a block diagram of a communications system consistent with the present invention.

FIG. 1A is a block diagram of a control system consistent with the present invention.

FIG. 2 is a flow diagram of a process for overwriting image data consistent with the present invention.

FIG. 3 is a block diagram of a hard disk drive (HDD) structure consistent with the present invention.

FIG. 4 is a block diagram of a file allocation table (FAT) consistent with the present invention.

FIG. 5 is a block diagram of a job classification table consistent with the present invention.

FIG. 5A is a detailed flow diagram of step 340, illustrated in FIG. 2.

FIG. 6 is a block diagram of a secure hardcopy device consistent with the present invention.

### DETAILED DESCRIPTION OF THE PREFERRED EMBODIMENTS

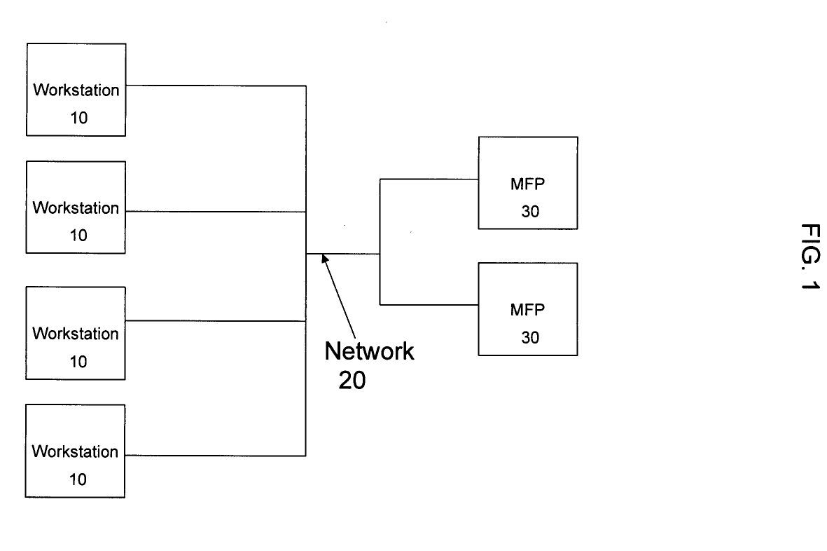

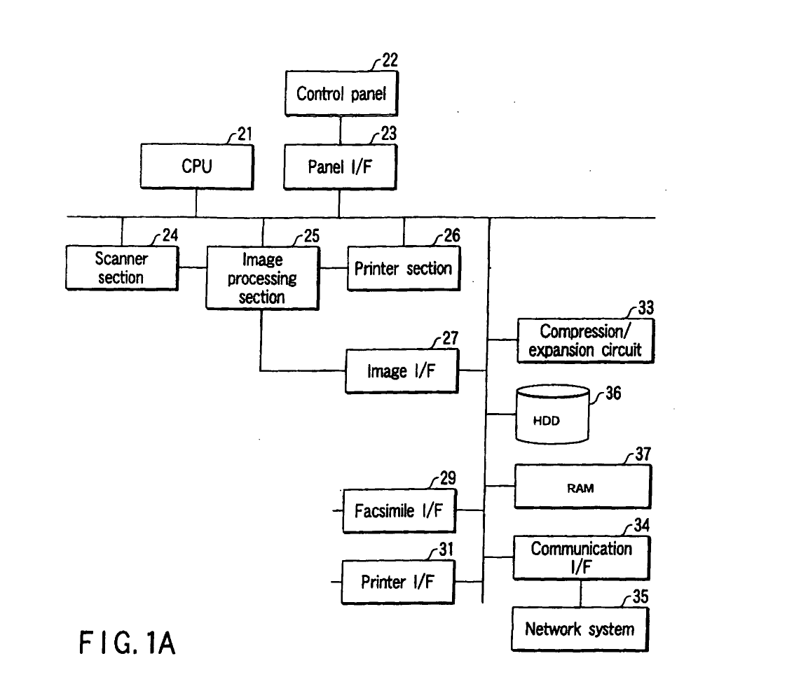

FIG. 1 is a block diagram of a communication system consistent with the present invention. As shown in FIG. 1, the communication system includes one or more workstations 10, a network 20, and one or more multi-function peripherals (MFPs) 30. Each of the workstations and each of the MFPs are coupled to the network 20. The network 20 may be implemented as a local network, such as a LAN, or as a public network, such as the Internet.

The workstation 10, which may be a PC or a server, includes a CPU, a main memory, a ROM, a storage device and a communication interface all coupled together via a bus in one embodiment consistent with the present invention. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive (HDD) or any other type of non-volatile, writable storage.

The communication interface for the workstation 10 provides a two-way data communication coupling via a network link to the network 20. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the network 20.

If the network is implemented as the Internet, the workstation 10 or server can transmit a requested code for an application program through the Internet, an Internet Service Provider (ISP), the local network and the communication interface. The received code can be executed by the CPU in the workstation 10 or server as it is received, stored in the storage device, or stored in some other non-volatile storage for later execution. In this manner, a user at the workstation 10 or server may obtain application code in the form of a carrier wave.

The MFP 30 is a device that can perform the functions of multiple devices, such as a printer, a fax machine, a copier, a plotter, a scanner or any other functional device that generates hardcopies of images or text. MFPs 30 are also known as multifunction printers. Like the workstation 10, the MFP 30 may have a CPU, a main memory, a ROM, RAM and a storage device such as an HDD and a communication interface all coupled together via a bus. The MFP 30 may also have a communication interface to provide a two-way data communication coupling via a network link to the network 20. The network link to the network 20 enables the MFP 30 to receive data from and to output data to the workstation 10. Instead of a network link, MFPs 30 may use a Universal Serial Bus (USB) to connect to a USB port on the workstation 10.

In operation, the workstations 10 communicate with the MFPs 30 via the network 20 or via a more direction connection, such as the USB. This communication enables the workstation 10 to request the MFP 30 to perform a function, such as printing a document or sending or receiving a fax. In addition, the workstation 10 can request information from the MFP 30.

To communicate with the MFP 30, the workstation 10 may use a network protocol such as the Simple Network Management Protocol (SNMP), which is a protocol for monitoring and managing systems and devices in a network. The functions supported by the protocol are the request and retrieval of data, the setting or writing of data, and traps that signal the occurrence of events. The data being monitored and managed is defined by a management information base (MIB). A MIB includes the specification and formal description of a set of objects and variables that can be read and possibly written using the SNMP protocol. SNMP and similar communication protocols can also be used with non-networked connections, such as USB, IEEE 1384 (FireWire) and IEEE 1284 (Parallel).

Each MFP 30 may have one or more users that are the primary users of that MFP 30. Like some other hardcopy devices, the MFP 30 stores certain information for proper operation. Generally, an MFP 30 is capable of receiving faxes from phone lines, via a LAN or the internet. Using similar communication methods an MFP 30 is also capable of receiving requests to copy, print or scan an image or a file. The MFP 30 processes the received job request and performs the function or job specified in the job request. The job request may require the MFP 30 to copy image data or print out image data sent via facsimile. Generally, the MFP 30 has an HDD, sometimes referred to as a box, that stores various information including image data related to job requests such as fax, copy, print or scan jobs. The HDD allocates storage for image data relating to each job type and job request received by the MFP 30.

With the growing concern for information security it would be useful for an MFP 30 to be capable of determining whether to store or delete image data received by the MFP 30 in response to a job request.

FIG. 1A is a block diagram of an MFP 30 control system consistent with the present invention. In order to process a job, a control panel 22 may be used to cause a CPU 21 to initiate a read procedure at a scanner section 24 via a panel interface 23. The image data from the read procedure is stored in an HDD 36.

The MFP 30 can communicate freely with other MFPs 30 via a network system 35. The image data received via the communication interface 34 and network system 35 is stored in the HDD 36. Image data received by facsimile via a telephone line or by other communication channels is sent to a compression/expansion circuit 33 via a facsimile interface 29. The image data received via facsimile is stored in the HDD 36 as image data. Similarly, printer data received via a printer interface 31 from an external device is stored in the HDD 36 as image data of a print job. Stored image data is printed at the printer section 26 via an image interface 27 and an image processing section 25.

As shown in FIG. 4, which is a diagram of a file allocation table, a File Allocation Table (FAT) 50 catalogues job types 52, job numbers 51 and hard drive address information 53 for image data stored in the HDD 36. The FAT can be located in a Random Access Memory (RAM) 37. The job type 52 can be, for example, a copy, print, fax, or scan job. The job number 51 is an identifier for a particular job submitted to the MFP 30. The hard drive address information 53 provides the addresses of the image data corresponding to the jobs submitted to the MFP 30.

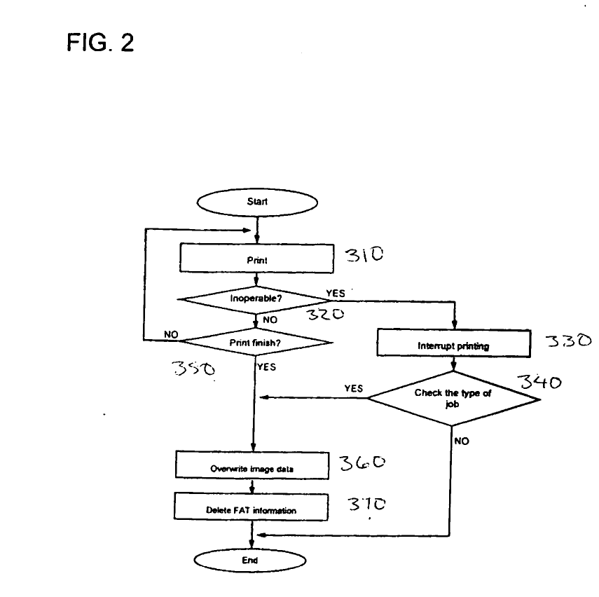

FIG. 2 is a flow diagram of a process for overwriting image data. Although the below process is described with respect to the operation of an MFP 30, it should be understood that the process of FIG. 2 is also applicable to any hardcopy device, such as a copier, a printer, a scanner or a fax machine, as well as combinations thereof. Further, the processing described with respect to FIG. 2 may be performed by the MFP 30 or other hardcopy device or may be performed by a device coupled to the MFP 30 or hardcopy device, such as a network server or workstation 10. For the purposes of the following description of the process of FIG. 2, steps performed by a device can refer to any of the MFP 30, other hardcopy device, server, or workstation 10. As shown in FIG. 2, during printing (step 310), the device detects whether an inoperable condition has occurred at the MFP 30 (step 320). Events that may cause an inoperable condition include, for example, a paper jam, a paper empty condition, a toner empty condition, the cover of the MFP 30 being open, or printing being interrupted or paused by a user or other printing application.

If there is an inoperable condition, the print function is interrupted (step 330). In addition, the device identifies the job type 52 and job number 51 being processed during the inoperable printing condition (step 340). The device overwrites the image data stored in the HDD 36 that is associated with the identified job type 52 and the identified job number 51 (step 360). The image data may be overwritten, for example, with FF values, 00 values, or random data.

In addition to overwriting the image data, the data stored in the FAT 50 associated with the job request is deleted (step 370). If there is not an inoperable condition, then when the printing is finished (step 350), the image data stored in the HDD 36 is overwritten (step 360), and the data stored in the FAT 50 related to a job request is deleted (step 370). In another aspect of the present invention, a deletion message is displayed if data stored in the FAT 50 is deleted or if image data stored in the HDD 36 is overwritten.

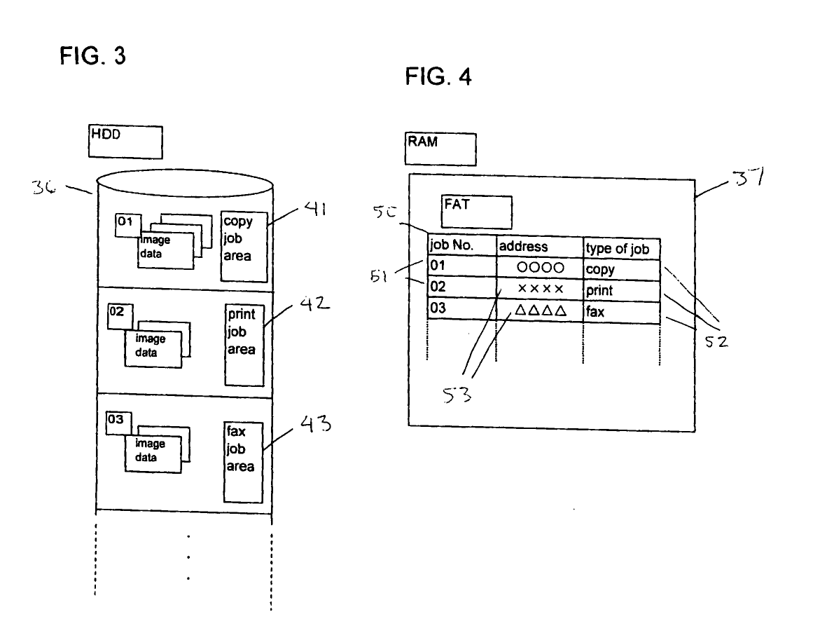

FIG. 3 is diagram of on embodiment of an HDD 36 in an MFP 30. In this aspect of the present invention, each job type 52 is allocated a storage area in the HDD 36, and each storage area stores image data of the jobs of the corresponding job type. In particular, a copy job area 41 stores image data associated with copy jobs, a print job area 42 stores image data associated with print jobs, and a fax job area 43 stores image data related to fax jobs.

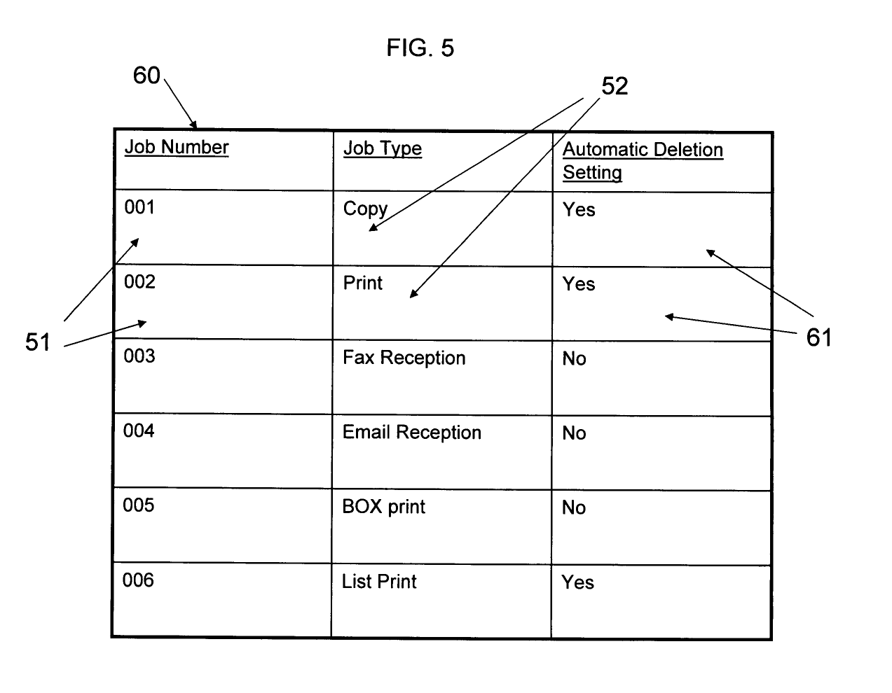

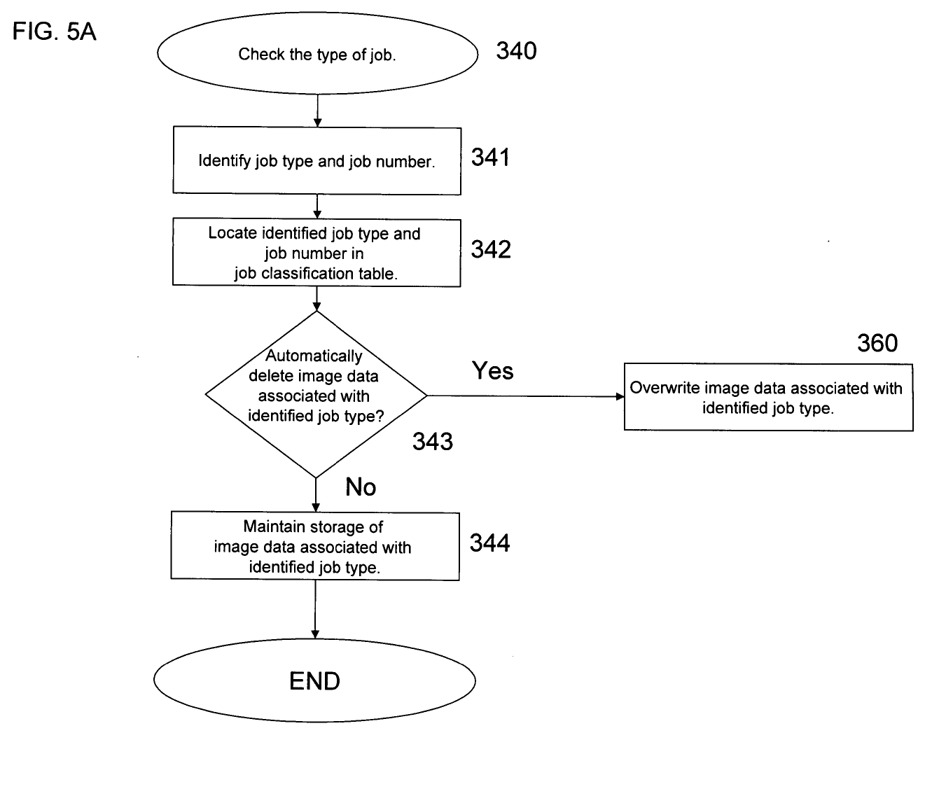

FIG. 5 is a diagram of a job classification table 60. In one embodiment of the present invention, a method for preventing access to image data includes storing an automatic deletion setting 61 for each of a plurality of job types 52 in a job classification table 60. In addition, a job number 51 may be assigned to each of a plurality of job types 52 in the job classification table 60.

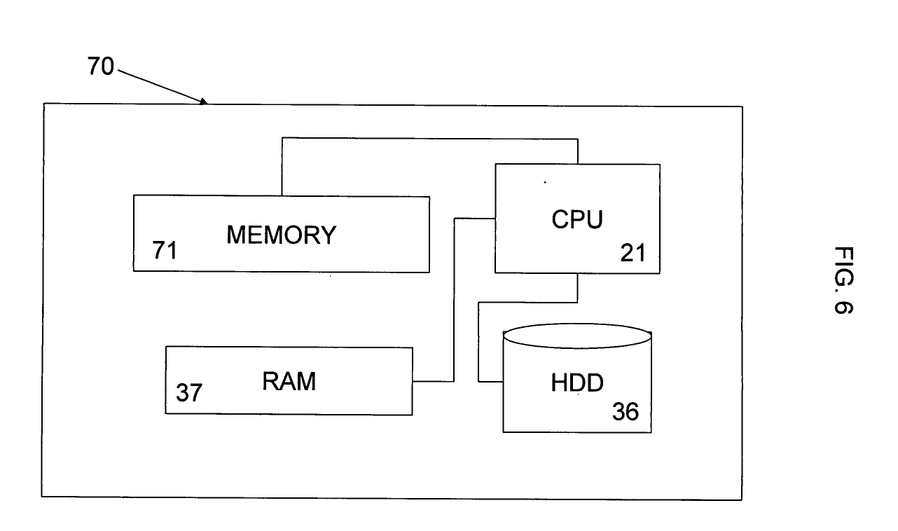

FIG. 6 is a block diagram of a secure hardcopy device 70 consistent with the present invention. In one embodiment of the present invention, the secure hardcopy device 70 comprises a CPU 21, an HDD 36, a RAM 37 and a memory 71, the HDD 36, the RAM 37, and the memory 71 are each coupled to the CPU 21. The memory 71 comprises a plurality of instructions executed by the CPU 21. The plurality of instructions stored in the memory 71 and executed by the CPU 21 include instructions configured to carrying out each aspect of the present invention including the processing of FIG. 2.

In the process of FIG. 2, a device is capable of detecting an inoperable condition, and identifying the job type 52 and the job number 51 being processed when the inoperable condition occurs. In an aspect of the present invention, reference is made to the job classification table 60 based on the identified job type 52 and job number 51 when the inoperable condition occurs. In accordance with the identified job type 52 and job number 51, the automatic deletion setting 61 is identified.

The automatic deletion setting 61 can be set in accordance with the particular job type 52. For example, as shown in FIG. 5, if the job type 52 is a copy job, then the automatic deletion setting 61 is set to YES, whereas if the job type 52 is a fax job, then the automatic deletion setting 61 is set to NO. If the automatic deletion setting 61 is set to YES, then the device overwrites the image data stored in the HDD 36 that is associated with the identified job type 52 and the identified job number 51. The overwritten image data may be, for example, the image data associated with a copy job or a print job.

However, if the automatic deletion setting 61 is set to NO, the device maintains the storage of the image data in the HDD 36 that is associated with the identified job type 52 and the identified job number 51. For example, if all of the image data of a fax job has been received and stored in the HDD 36, but not printed, then the image data of the fax job is maintained in the HDD 36. As a result, once the inoperable condition is resolved, the printing of the fax job can be completed without the sender of the fax job resending the fax.

FIG. 5A is a detailed flow diagram of step 340, previously illustrated in FIG. 2. As shown in FIG. 5A when the device checks the type of job (step 340), it first identifies the job type 52 and job number 51 associated with the current job request (step 341). The device then locates the identified job type 52 and job number 51 in the job classification table 60 (step 342). The device references the corresponding automatic deletion setting 61 for the identified job type (step 343). The automatic deletion setting 61 indicates whether the image data associated with the identified job type 52 should be overwritten or maintained. In one embodiment of the invention, if the automatic deletion setting 61 is set to YES, then the device overwrites the image data associated with the identified job type 52 (step 360). If the automatic deletion setting 61 is set to NO, then the device maintains the associated image data (step 344).

In another aspect of the present invention, a user may edit the job classification table 60. To edit the job classification table, the user may set the device to an administration mode and request to edit the job classification table. In response to the edit request, the device displays the current settings of the job classification table 60. The user can modify the automatic deletion setting 61 for a job type 52 and save the modifications made to the job classification table 60. Subsequent jobs submitted to the MFP 30 are processed in accordance with the modifications made to the job classification table. For example, if the user changes the automatic deletion setting 61 for a box print for a fax job from NO to YES, then the image data of the fax job is deleted from the HDD 36 of the MFP 30 if an inoperable printing condition occurs during the fax job.

In accordance with the present invention, image data stored in the HDD 36 can be deleted if an inoperable condition of the MFP 30 arises. As a result of the deletion of the image data, a user not authorized to access the image data is not able to access the image data. Further, it is possible to condition the deletion of the image data in response to an inoperable condition based on the job type. For example, if the inoperable condition arises during a print or copy job, then the image data can be deleted, which negates the risk of unauthorized access of the image data associated with the print or copy job. Moreover, it is relatively simple for the user to resubmit the print or copy job after the inoperable condition is resolved. On the other hand, if the inoperable condition arises during a fax job, then it is possible to maintain the image data in the HDD 36 and print it after the inoperable condition is resolved. As a result, it may be unnecessary for the sender to resend the fax, which is relatively inconvenient as compared to the resubmission of the print or copy job.

The foregoing description of a preferred embodiment of the invention has been presented for purposes of illustration and description. It is not intended to be exhaustive or to limit the invention to the precise form disclosed, and modifications and variations are possible in light of the above teaching or may be acquired from practice of the invention. The embodiment was chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is:

1. A method for controlling access to image data in a hardcopy device comprising:
receiving a job request;
storing image data associated with the job request onto a storage medium;
detecting an inoperable condition of the hardcopy device; and
overwriting the image data associated with the job request in the storage medium when the inoperable condition is detected.

2. A method according to claim 1, wherein the hardcopy device is a multi-function peripheral device.

3. A method according to claim 1, wherein the job request includes a job type, the job type being one of a fax job, a print job, a copy job, an e-mail job a list print job, and a box print job.

4. A method according to claim 1, further comprising:
detecting a job type of the job request; and
determining whether to overwrite the image data based on the job type of the job request.

5. A method according to claim 4, further comprising maintaining the storage of the image data if the job type of the job request is a fax job.

6. A method according to claim 4, further comprising storing an automatic deletion setting for each of a plurality of job types in a job classification table.

7. A method according to claim 6, wherein the automatic deletion setting for at least one job types is set to a first setting, and the automatic deletion setting for at least one other job type is set to a second setting.

8. A method according to claim 7, further comprising:
overwriting the image data if the automatic deletion setting in the job classification table for the detected job type of the job request is set to the first setting; and
maintaining the storage of the image data if the automatic deletion setting in the job classification table for the detected job type of the job request is set to the second setting.

9. A method according to claim 6, further comprising changing at least one of the automatic deletion settings in the job classification table.

10. A method according to claim 9, wherein the changing step includes:
changing the hardcopy device to an administration mode;
receiving a request to edit the job classification table;
displaying the job classification table;
modifying the automatic deletion setting for a job request type in response to a received setting modification; and
saving the modifications made to the job classification table.

11. A hardcopy device comprising:
a processor;
a hard disk drive (HDD) coupled to the processor;
a memory, coupled to the processor, comprising a plurality of instructions executed by the processor, the plurality of instructions configured to:
receive a job request;
store image data associated with the job request;
detect an inoperable condition of the hardcopy device; and
overwrite the image data associated with the job request when the inoperable condition is detected.

12. A secure hardcopy device according to claim 11, wherein the hardcopy device is a multi-function peripheral device.

13. A secure hardcopy device according to claim 11, wherein the job request includes a job type, the job type being one of a fax job, a print job, a copy job, an e-mail job, a list job and a box print job.

14. A secure hardcopy device according to claim 13, the memory further comprising an instruction configured to assign a job number to the job request.

15. A secure hardcopy device according to claim 14, the memory further comprising instructions configured to:
copy the image data onto the HDD;
store the job number; and
store the job type.

16. A secure hardcopy device according to claim 13, the memory further comprising instructions configured to:
detect a job type of the job request; and
determine whether to overwrite the image data based on the job type of the job request.

17. A secure hardcopy device according to claim 16, the memory further comprising an instruction configured to store an automatic deletion setting for a plurality of job types in a job classification table.

18. A secure hardcopy device according to claim 17, wherein the automatic deletion setting for at least one job type is set to a first setting, and the automatic deletion setting for at least one other job type is set to a second setting.

19. A secure hardcopy device according to claim 18, the memory further comprising instructions configured to:
overwrite the image data if the automatic deletion setting in the job classification table for the detected job type of the job request is set to the first setting; and
maintain the storage of the image data if the automatic deletion setting in the job classification table for the detected job type of the job request is set to the second setting.

20. A method for controlling access to image data in a multifunction peripheral device comprising:
receiving a job request, wherein the job request includes a job type, the job type being one of a fax job, a print job, a copy job, an e-mail job a list print job, and a box print job;
storing image data associated with the job request onto a storage medium;
storing a job number and the job type of the job request in a file allocation table;
storing, in the file allocation table, an address at which the image data associated with the job request was stored in the storage medium;
detecting an inoperable condition of the multifunctional peripheral device;
detecting the job type of the job request;
determining whether to overwrite the image data based on the job type of the job request if an operable condition is detected;
determining if the job request is complete; and
deleting the image data associated with the job request stored in the file allocation table if the job request is determined to be complete.
